(19) United States
(12) Patent Application Publication
(10) Pub. No.: US 2007/0210605 A1
(43) Pub. Date: Sep. 13, 2007

(54) Double sun visor

(76) Inventor: Carl Solomon SR., Suisun City, CA (US)

Correspondence Address: Carl Solomon Sr., 65 Rodondo Avenue, Suisun City, CA, 94585, US

(21) Appl. No.: 11/284,054

(22) Filed: Feb. 27, 2006

(51) Int. Cl. B60J 3/00

(52) U.S. Cl. 296/97.6

(57) ABSTRACT

The Double Sun Visor is an improvement in the design of the existing Single Sun Visor found in all motorized vehicles. Vehicles include automobiles, buses, trucks, recreation vehicles, aircraft, and construction vehicles. The Double Sun Visor is comprised of two identical equal size Sun Visors which are attached the vehicle ceiling right above the vehicle's windshield on both the driver side and passenger side of the vehicle. A pivoting arm allows the driver and passenger to move and position one Sun Visor to their front view and one Sun Visor to their side view in order to block sunlight entering the windows, providing additional safety and eye protection to the driver and the passenger.

I, Carl Solomon Sr. have invented a design for a (Title) Double Sun Visor as set forth in the following specification:

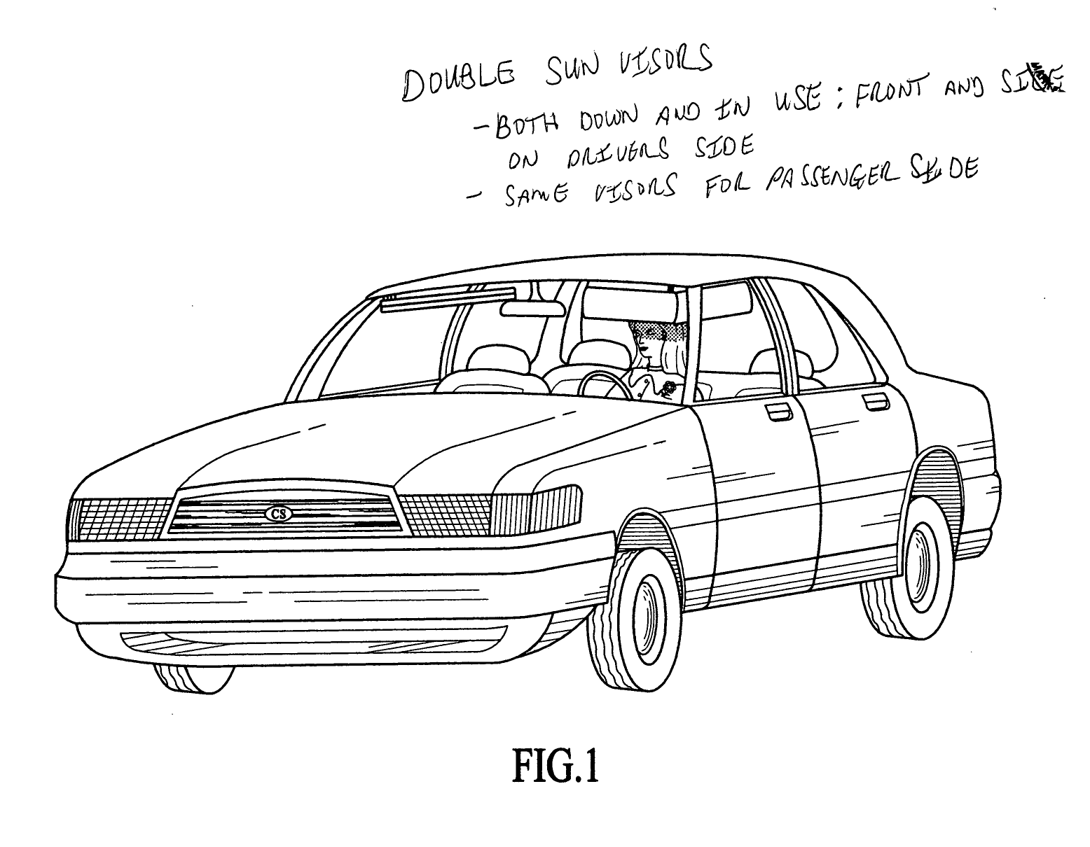

FIG. 1 is a forward view showing my design of the Double Sun Visor in the closed and stored position (driver or passenger side).

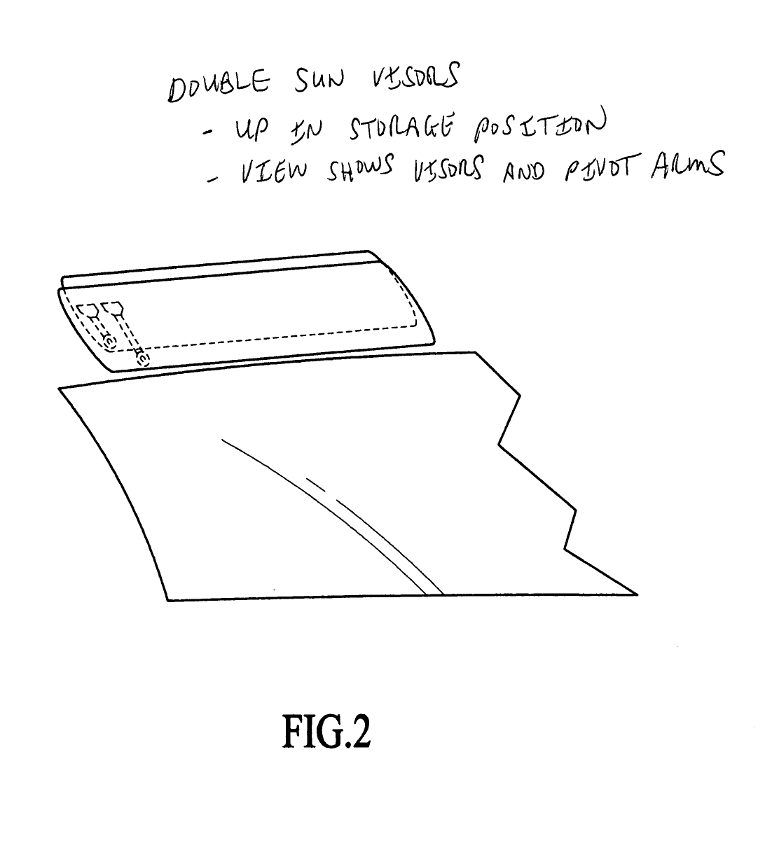

FIG. 2 is a forward view showing both visors extended down in the open position to block sunlight coming in the windshield only (driver or passenger side).

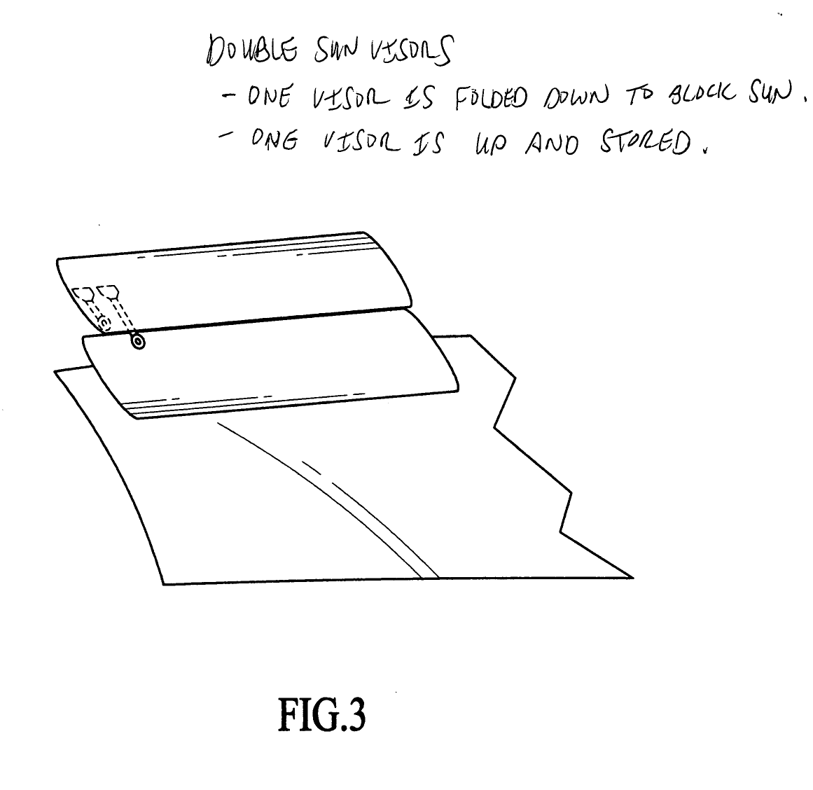

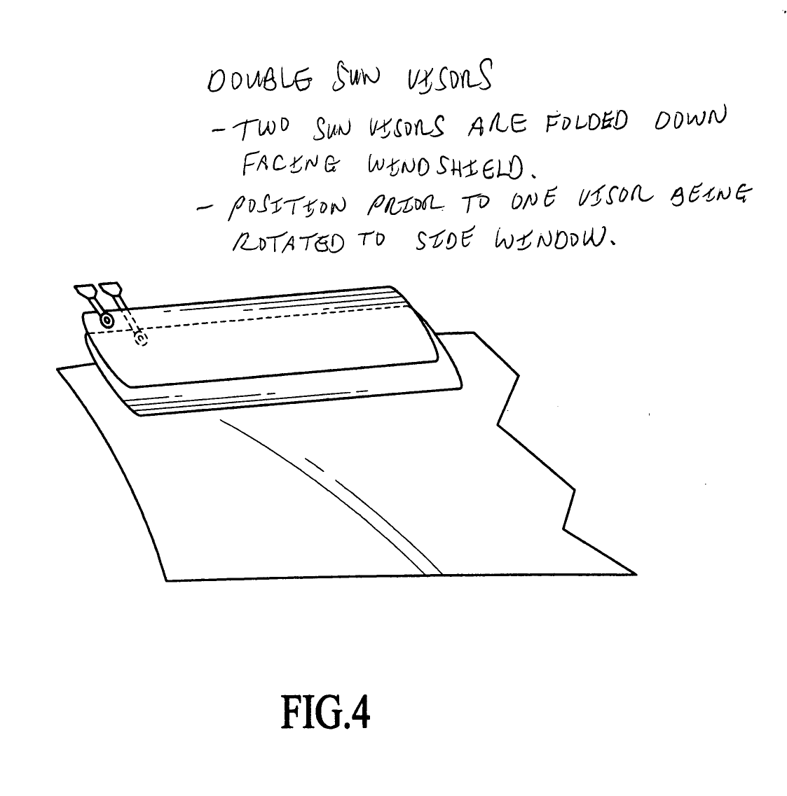

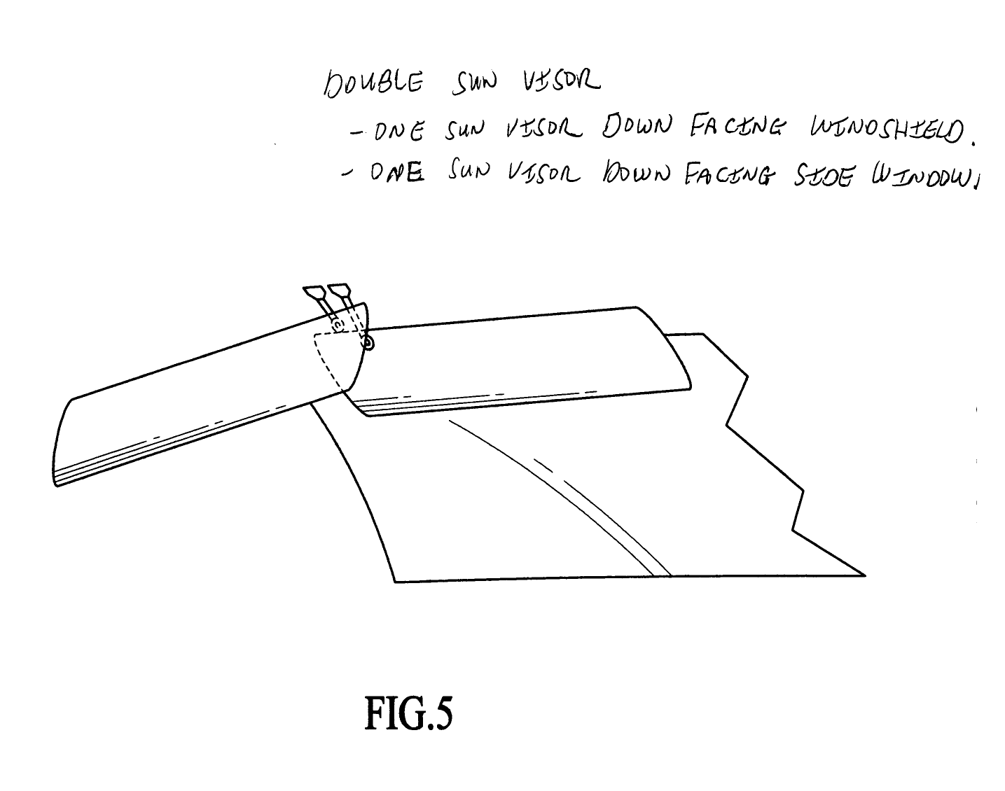

FIG. 3 is a view of the front and side sun visors in the open position to block sunlight entering in the windshield and the side window (driver or passenger side).

I claim: the utility design for a double sun visor as shown.

1. Double Sun Visor does not currently exist.

2. Double Sun Visor is to be installed on both the driver side and passenger side of the vehicle.

3. Double Sun Visor can be installed in any vehicle currently using Single Sun Visors.

4. Double Sun Visor consists of two Sun Visors that, when both are in use, one Sun Visor is facing the windshield and one Sun Visor is facing the side window on driver or passenger side.

5. Double Visor will block sun light and headlight.

6. Double Visor can be produced in various sizes, materials, and colors
